(19) United States
(12) Patent Application Publication
(10) Pub. No.: US 2018/0023234 A1
(43) Pub. Date: Jan. 25, 2018

(54) SYSTEMS AND METHODS FOR WATER REPELLENT TREATMENT OF PROTECTIVE FABRICS, AND PROTECTIVE FABRICS MADE USING SAME

(71) Applicants: Shekoufeh SHAHKARAMI, Cambridge (CA); Andrew GALBRAITH, Cambridge (CA)

(72) Inventors: Shekoufeh SHAHKARAMI, Cambridge (CA); Andrew GALBRAITH, Cambridge (CA)

(21) Appl. No.: 15/528,050

(22) PCT Filed: Nov. 19, 2015
(86) PCT No.: PCT/CA2015/051204

§ 371 Date: May 18, 2017

Related U.S. Application Data
(60) Provisional application No. 62/081,788, filed on Nov. 19, 2014.

(51) Int. Cl. D06B 3/10; D06B 21/00; D06C 7/02; B05D 3/04; B05D 1/02; B05D 1/18; B05D 1/28; B05D 3/06; D06B 15/04; D06M 15/00

(52) U.S. Cl. CPC D06B 3/10; D06B 15/04; D06B 21/00; D06C 7/02; D06M 15/00; B05D 1/02; B05D 1/18; B05D 1/28; B05D 3/06; B05D 3/0493; D06M 2200/12

(57) ABSTRACT

According to some aspects, water repellent treatments for fabrics. More particularly, systems and methods for water repellant treatment of protective fabrics for ballistic and other applications, and protective fabrics made using such techniques.

### TECHNICAL FIELD

The embodiments herein relate to water repellent treatments for fabrics, and particularly to systems and methods for water repellant treatment of protective fabrics for ballistic and other applications, and protective fabrics made using such techniques.

### INTRODUCTION

Fabrics, such as protective fabrics for ballistic and other applications, are often subjected to fabric finishing processes. One example is a water repellency treatment in which chemicals or other compounds are applied to a fabric to improve the resistance of the fabric to water.

Improving the water repellent properties of fabrics can be beneficial to ensure that desired levels of performance are maintained in wet conditions. For example, in a ballistic fabric it is desirable that the fabric continue to inhibit or stop projectiles of a certain size and velocity even when wet, ensuring that personnel wearing such fabrics are still protected.

Increasing the water repellency of fabrics may also be useful for increasing the longevity of the fabric. For example, water repellent treatments may lower the surface friction and hence enhance the abrasion resistance of fabric. In some cases, it may also lower the moisture regain of a fabric by 3-8%, which results in weight advantage.

Some processes for providing water repellency to fabrics are known. However, a number of these processes require large and complex equipment, which is undesirable.

### BRIEF DESCRIPTION OF THE DRAWINGS

The drawings included herewith are for illustrating various examples of systems, methods and apparatuses of the present specification and are not intended to limit the scope of what is taught in any way. In the drawings:

FIG. 1 is a schematic illustration of a system for providing a water repellant treatment to fabrics according to one embodiment.

### DETAILED DESCRIPTION

Various techniques and processes will be described below to provide an example of the claimed subject matter. No example described below limits any claim, and any claim may cover processes or apparatuses that differ from those described below. The claims are not limited to techniques or processes (or fabrics made therefrom) having all of the features of any one technique or process described below, or to features common to multiple or all of the teachings herein.

It is possible that a technique or process described below is not an embodiment of any exclusive right granted by issuance of this patent application. Any subject matter disclosed herein and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

As introduced above, fabrics (including protective fabrics for ballistic and other applications) are often subjected to fabric finishing processes to improve their water repellency properties.

One approach to improving the water repellency of fabrics is performed by curing water repellent compounds on a fabric using a “tenter frame” oven. Tenter frames are large and fairly expensive manufacturing-scale ovens that use gas or electric elements to provide primarily for convective heating as a fabric passes through the oven. This convective heat cures the water repellent compound onto the fabric.

Prior to entering the tenter frame, the fabric is coated with a water-repellent chemical or other compound using various chemical application systems, such as a dip tank and padders. Padders are well known in fabric finishing, and generally involve using heavy rollers to squeeze excess liquid from a fabric, resulting in a fairly consistent amount of liquid retention in the fabric.

For instance, a fabric may be dipped into a dip tank that contains a liquid compound (i.e., a fluoropolymer water-repellent polymer) and then pass through padders that squeeze the fabric to remove excess polymer. After the excess polymer is removed, the fabric can then be cured in a high temperature tenter frame oven to set the polymer.

Other heating or curing systems have been explored over years without much success. It is believed that this is mainly due to the residence times and temperatures that were traditionally understood to be necessary for curing water repellency treatments in fabrics (particularly fluoropolymer compounds) according to the information specified by chemical suppliers of the compounds.

As discussed herein, however, new techniques have been discovered and developed that are believed to provide for effective water-repellency for fabrics, even when operated under conditions that may be inconsistent with the teachings of the chemical suppliers.

In particular, the use of an infrared (IR) heating system was studied to provide curing using temperature settings that are less than the temperature settings specified by chemical suppliers as necessary for curing. Moreover, the use of a slot vacuum system was explored as a possible alternative to using padders to remove excess liquid from a dipped fabric.

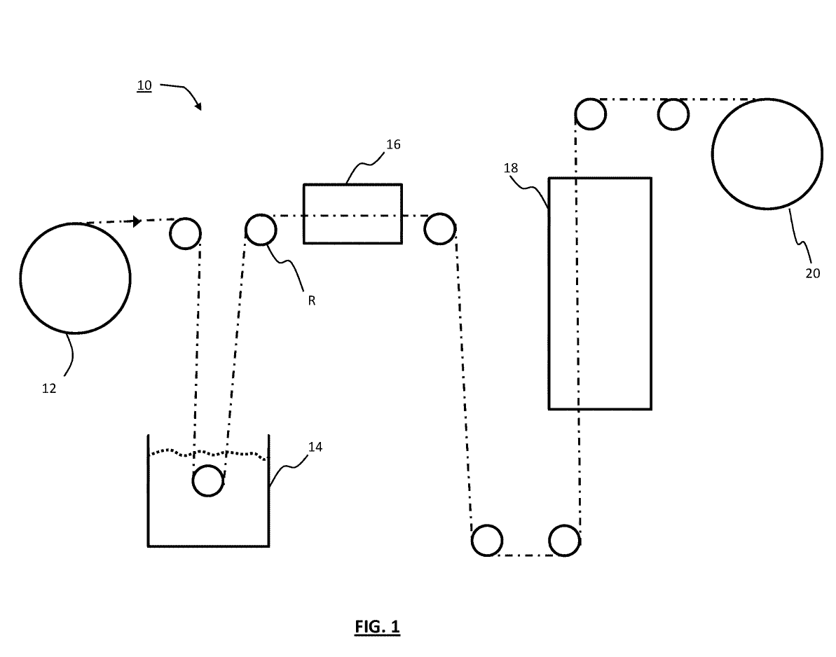

Turning now to FIG. 1, illustrated therein is a system 10 for treating fabrics for water repellency according to one embodiment.

The system 10 includes a first roller 12 (or a supply roller) that includes “raw fabric” to be treated. In general this raw fabric can be any fabric, such as a protective fabric made using aramid fibers (or other fibers) and which may be suitable for ballistic protection, spike protection, stab protection, or some combination thereof.

In general the raw fabric is unwound from the first roller 12 and then passes into a dip tank 14. The dip tank 14 includes a water repellent compound therein, such as a liquid fluoropolymer or other water repellent fabric. As the fabric passes through the dip tank 14, the water repellent compound contacts the fabric and adheres to or “wets” the fabric to form a “wetted fabric”. This “wetted fabric” generally includes excess water repellent compound thereon, which must be removed after the leaving the dip tank 14.

In other examples, different techniques could be used for applying the liquid compound to the fabric to form the “wetted fabric”, such as spray techniques, transfer rolls, and so on.

In this embodiment, the “wetted fabric” passes into a vacuum module 16 to remove excess liquid (although in other embodiments padders could be used to remove excess liquid). In particular, the vacuum module 16 is operable to remove excess liquid compound from the fabric so that a desired amount of water repellent compound remains on the fabric, thus forming a “pre-cured fabric” that is ready for curing.

In one embodiment the vacuum module 16 may include one or more vacuum slots that apply a vacuum to the fabric as it passes through vacuum module 16. These vacuum slots apply suction to the fabric to remove excess water repellent compound to form the “pre-cured fabric”. Moreover, the use of these vacuum slots is also believed to be beneficial at encouraging the water repellent compound to penetrate into the fabric, so that the compound is not simply resident on the surfaces of the fabric but may come to surround at least a significant portion of the individual fibers in the fabric.

In some embodiments the vacuum slots may be transversely oriented to the direction of travel of the fabric. In some embodiments, the vacuum module may include a vacuum grate over which the fabric passes.

After leaving the vacuum module 16, the “pre-cured fabric” then passes into an infrared (IR) heater 18 where the water repellent compound is cured, forming a “treated fabric”.

In general, an IR heater 18 is a high temperature heater that includes heating elements provides heat to the fabric primarily through electromagnetic radiation. As such, no physical contact is required between IR heater 18 and the fabric to effect curing. Moreover, although some convective heat transfer may occur between the IR heater 18 and the fabric, convective heat transfer is not believed to be the primary mode of heat transfer, and indeed may not necessarily be required to effect curing.

After leaving the IR heater 18, as shown in FIG. 1 the “treated fabric” may then be collected on a second roller 20 (or collection roller). From here the “treated fabric” may then be used to form protective equipment, such as protective vests, armor panels, and the like. The “treated fabric” may also be subjected to other finishing processes as are generally known in the art.

As shown in FIG. 1, as the fabric passes through the various elements of the system 10 (i.e., the dip tank 14, vacuum module 16, IR heater 18, etc.) the fabric may be guided using one or more other rollers R, which could include idler rollers or powered rollers as may be desirable to obtain the desired movement of the fabric through the system 10, as well as controlling fabric tension and roll-up alignment.

In some embodiments, after leaving the IR heater 18 a first time (i.e., in a “first pass”), a “treated fabric” may be subjected to a “second pass” through the IR heater 18. This may be useful, for example, when higher degrees of water repellency properties are desired, and which may require a second curing step.

In some embodiments, a second pass may include passing the “treated fabric” through the IR heater 18 a second time. In other embodiments, the second pass may also include other steps, such as passing the “treated fabric” through the vacuum module a second time, or indeed applying a second coating by passing the “treated fabric” through another dip tank and then through another vacuum module before passing through the IR heater 18 a second time. In some cases, this second pass may encourage better penetration of the coating into the fabric. Moreover, in some cases the use of a second pass may allow for multiple coatings to be applied to the same fabric (for example, different water repellent coatings may be applied to the same fabric by using multiple dip tanks with different coatings).

In some embodiments, a third or fourth pass could be undertaken, as desired, by generally repeating one of more of the steps as described above.

### Summary of IR and Vacuum Water Repellency Trials

A series of experiments were conducted to explore the performance of a system for treating fabrics for water repellency, such as the system 10 described above. In particular, experiments were conducting using a vacuum module (having vacuum slots) for applying a desired amount of fluoropolymer water repellent compound to a fabric (instead of using padders), and an IR heater module was used for curing of the water repellent compound (instead of a tenter frame).

For all trials described below, standard scouring and drying procedures were used, as well as standard fluoropolymer water repellent chemical types and concentrations that are commercially used for each of the different fabric styles.

### Experiment #1

The first round of trials were set up to test the use of an IR heating module using two common types of fabric: FABRIC A (Twaron 550 DTEX 28×28) and FABRIC B (Twaron 930 dtex 27×27). Scoured fabrics were dried using standard drying techniques. A water repellent compound was then applied to the fabrics using a dip tank and conventional padder system. An IR heating module was used for curing and heat setting of the of the water repellent compound.

The IR module was alternatively set at low and high temperature settings, and was operated at a speed of 3 meters per minute). Note that it may be possible for the speeds to be varied (in some cases varied greatly), for instance by using additional heaters 18 and/or heating elements.

In the absence of a reference gauge for performance of the IR heating effects, a two-pass curing run was set up for the low temperature set-up, and a one-pass curing run for the high temperature set-up.

In general, the heaters were operated at temperature settings of between about 200 to 270 degrees Fahrenheit. More particularly, for this experiment the heaters were operated at temperature settings of approximately 220 degrees Fahrenheit for the low temperature set-up (which proved to be adequate and was used for subsequent trials), while the heaters were operated at temperature settings of approximately 250 degrees Fahrenheit for the high temperature set-up. It will of course be appreciated that the temperature settings might be machine dependent. It is also noted that scorching of fabrics was observed when the heaters were operated at a temperature of around 285 degrees. Note that in this example the temperature readings were taken using a thermometer (in this case a pyrometer) located inside the IR module near the fabric exit from the IR module. As such, these readings are expected to generally approximate the fabric temperature as it exits the IR module.

The two-pass low temperature setting for the IR heater was expected to be more effective, and hence full ballistic testing was conducted (i.e., 9 mm V50). However, small samples were also taken from the one-pass low temperature set-up, as well as one-pass high temperature set-up, to assess the water repellency performance of the different set-ups.

Samples were evaluated against a typical submersion test, stiffness test (where lower results for submersion and stiffness are desirable), and 9 mm ballistic test higher numbers for ballistic performance are desired. Both submersion and stiffness tests are in accordance to ‘Canadian FPV Spec’. Test results for this first round of trials were as follows:

TABLE 1
Fabric A Performance

| | Submersion | Stiffness | 9 mm (m/s) |
|---|---|---|---|
| Sample ID | SOP37 | STM27 | MIL-STD-662F |
| FABRIC A Low | 22%, 22% | | — |
| Temperature one pass | | | |
| FABRIC A Low | 21%, 22%, 23% | 0.72 | 430 |
| Temperature two passes | | | |
| FABRIC A High | 24%, 25%, 24% | 0.89 | — |
| Temperature one pass | | | |
| Standard FABRIC A WR | 26% | 0.87 | 436 |

TABLE 2
Fabric B Performance

| Sample ID | Submersion | Stiffness | 9 mm (m/s) |
|---|---|---|---|
| FABRIC B Low | 18.4% | — | — |
| Temperature one pass | & 16.8% | | |
| FABRIC B Low | 17%, 18%, 19% | 2.57 | 461 |
| Temperature two passes | | | |
| FABRIC B High | 17%, 17%, 16% | 2.7 | — |
| Temperature one pass | | | |
| Standard FABRIC B WR | 20-30% | 2.26 | 465 |

This first round of trials demonstrated that the use of an IR heater module for curing water repellent compounds is viable. Moreover, the use of an IR heater (as compared to a tenter-frame) may provide advantages related to lower capital costs, lower operation costs, and a smaller physical footprint.

In this experiment, since the IR heater module provided for heat transfer using both radiation and convection, the temperature settings of the IR heater could generally not be correlated to temperature settings that are normally used in a conventional tenter-frame. For example, chemical manufacturers normally state that a tenter-frame must be operated at a temperature of about 350 degrees Fahrenheit to cure fluoropolymers for water repellent treatment.

In contrast, the temperature settings of the IR heater in this experiment were between 220 degrees Fahrenheit and 250 degrees Fahrenheit.

Moreover, when the IR heater was operated at a temperature of 280 degrees Fahrenheit (close to, but still below the manufactures recommended temperature) the fluoropolymer turned black and had a “charred” appearance, although mechanical performance did not appear to be adversely affected. This suggests that the heat transfer mechanisms between the IR heater and the tenter-frame are quite different.

### Experiment #2

For a second round of trials, the use of an IR heating module for curing was examined in combination with the use of a vacuum module (having vacuum slots) for fluoropolymer impregnation. Table 3 below summarizes the results:

TABLE 3
IR heater and Vacuum Module Investigation Results

| | | | | | 9 mm | | |
|---|---|---|---|---|---|---|---|
| | WR application | | | Tenter- | V50 at | | |
| Trials | Padder | vacuum | IR | frame | 29L | Submersion | Stiffness |
| FABRIC A one pass, | ON | OFF | ON, | OFF | 428 | 27% | 0.6 |
| Padder application | | | one | | | | |
| | | | pass | | | | |
| FABRIC A two | ON | OFF | ON, | OFF | 435 | 27% | 0.87 |
| passes, Padder | | | two | | | | |
| application | | | passes | | | | |
| FABRIC A one pass, | OFF | ON | OFF | ON | 435 | 31% | — |
| vacuum application | | | | | | | |
| and tenter-frame | | | | | | | |
| cure | | | | | | | |
| FABRIC A two | OFF | ON | ON, | OFF | 451 | 21% | 0.77 |
| passes, vacuum | | | two | | | | |
| application and IR | | | passes | | | | |
| cure | | | | | | | |

These trials demonstrate that the combination of a vacuum module for fluoropolymer impregnation and an IR heater module for curing proved to result in the highest performance. More particularly, water repellency treatment in most cases tends to deteriorate the 9 mm ballistic performance but in this case the combination of the vacuum module and IR heater resulted in a treated fabric with both high ballistic performance (451 for 9 mm) and good water repellency properties (submersion of 21%).

### Experiment #3

For this third round of trials, the combination of a vacuum module an IR heater was further explored. Table 4 below summarizes the results:

TABLE 4
Further Exploration of IR and Vacuum Combination

| | WR application | | | | | 9 mm | |
|---|---|---|---|---|---|---|---|
| Trials | padder | vacuum | IR | Tenterframe | Submersion | V50 | Stiffness |
| FABRIC A two passes, | OFF | ON pass | ON | OFF | 34% | 438 | 0.65 |
| vacuum application and | | one only | | | | | |
| IR cure | | | | | | | |
| FABRIC A two passes, | OFF | ON both | ON | OFF | 25% | 441 | 0.83 |
| vacuum application and | | passes | | | | | |
| IR cure | | | | | | | |
| FABRIC A one pass, | OFF | ON | OFF | ON | 26% | 432 | 0.55 |
| vacuum application and | | | | | | | |
| tenter cure | | | | | | | |

Results from the third set of trials are in agreement with the previous trial, demonstrating the performance advantages in both water repellency and 9 mm ballistic performance when a two-pass technique uses the vacuum module during both passes for chemical impregnation, and an IR heater is used for curing.

In addition this technique appears to be particularly effective for three dimensional fabric structures. Specifically, penetration of the fluoropolymer into the core of fabric structure is promoted using the vacuum module to encourage physical movement of the water repellent compound into the inner regions of the fabric.

In particular, it is believed that, in a two-pass technique, the first pass through the vacuum module and IR heater starts the impregnation of the water repellent compound into the fabric, and partially cures the compound; the second pass through the vacuum module can then encourage further penetration of any uncured water repellent compound into the fabric, which is then further cured during the second pass through the IR heater.

In general, the vacuum pressure settings were high in these cases which resulted in much lower chemical add-on to the fabric, as compared to the use of padders, for example, which present a very different impregnation mechanism.

More particularly, the amount of liquid compound “picked up” by the fabric during each pass was much less than with padders. For example, in this example the liquid pickup tended to be in range of 6-8% by weight using the vacuum, as compared to about other ranges that might be around 15-20% for padders, for instance.

Thus, even a two-pass application of liquid compound using the vacuum system will tend to apply less liquid compound than what occurs with, while still providing improved penetration since the liquid compound tends to be “drawn” into the fabric. It is also speculated that the vacuum system may provide some additional drying effects, by removing excess water that may already be present in the fabric (and which might inhibit the effects of the liquid compound).

It is believed that this may provide for fabrics that have relatively more liquid compounds (i.e., fluoropolymers) and less water. Moreover these techniques appear to allow for greater control of the quantities of liquid compounds applied to the fabric, particularly to get concentrations below those that can be obtained using other techniques (i.e., padders).

### Fabric Types

In some examples, the fabrics subjected to the water repellent treatments as described herein may be a ballistic protective fabric made of ballistic yarns having a tenacity of at least about 15 grams per denier and higher, and with a tensile modulus of at least about 400 grams per denier.

Some examples of yarns that could be used in fabrics include carbon, basalt and glass fibers. Other examples include aramid and copolymer aramid fibers (produced commercially by DuPont and Teijin under the trade names Kevlar®, Twaron®, and Technora®), extended chain polyethylene fibers (produced commercially by Honeywell, and DSM, under the trade names Spectra®, and Dyneema®), polyethylene fibers and films produced by Synthetic Industries and sold under the trade name Tensylon®, poly(p-phenylene-2,6-benzobisoxa-zole) (PBO) (produced by Toyobo under the commercial name Zylon®), and Liquid crystal polymers produced by Kuraray under the trade name Vectran®. Other suitable yarns may also be used, such as AuTx OR Russian aramids like Rusar.

In some examples, the fabric may include other fibers. For example some fibers could include natural fibers, such as cotton, wool, sisal, linen, jute and silk. Other suitable fibers include manmade or synthetic fibers and filaments, such as regenerated cellulose, rayon, polynosic rayon and cellulose esters, synthetic fibers and filaments, such as acrylics, polyacrylonitrile, modacrylics such as acrylonitrile-vinyl chloride copolymers, polyamides, for example, polyhexamethylene adipamide (nylon 66), polycaproamide (nylon 6), polyundecanoamide (nylon 11), polyolefin, for example, polyethylene and polypropylene, polyester, for example, polyethylene terephthalate, rubber and synthetic rubber and saran. Glass, carbon or any other high performance fiber may also be used.

Staple yarns may also be used in the fabrics, and may include any of the above fibers, low denier staple yarns or any combination of these yarns. Staple yarns, by the discontinuous nature of their filaments that form the yarn, tend to have much lower tensile and modulus properties as opposed to yarns composed of continuous filaments.

Some of the fabrics described herein may generally be used in any combination with the materials listed above and may replace any one material or combination of materials in an existing ballistic fabric.

In addition, the treated fabrics as generally described herein may be laminated together or laminated with films to produce ballistic elements for various applications, including soft armor applications, hard armor applications, and rigid and/or semi-rigid applications.

The proportions of each material selected and the design of the ballistic elements may vary depending on the intended application (i.e. particular specifications for military or police applications).

In some embodiments, the fabrics described herein may be used in armor systems.

In some embodiments, one or more fabrics as generally described herein may be suitable for ballistic applications, and/or other types of threats, such as stab or spike threats. For example, some fabrics may be suitable against stab or spike threats in addition to (or as an alternative to) being effective against ballistic threats. In particular, there is a need, especially in fields like law enforcement and for use in correctional facilities (i.e., jails, prisons, etc.), for protective clothing that provides some protection for a wearer against penetration of a variety of dangerous instruments, such as blades, picks, shanks, awls, and the like.

In some embodiments, the fabrics as described herein may be used in the manufacture of multi-threat articles that may include a stab, spike or puncture resistant component in addition to a ballistic component. In some embodiments, the fabrics described herein may be used with ceramics or other materials suitable for stab-resistant product designs for spikes and edged weapons.

Finished articles that may make use of the fabrics include, but are not limited to, body armor, personal armor plates and shields, commercial vehicle armor, military vehicle armor, such as spall liners, fragmentation kits, IED protection, EFP protection, ship armor, helmets, structural armor, or generally any other application.

In some embodiments, the teachings herein may be useful for other fabrics, such as fire-resistant fabrics, non-ballistic fabrics, and so on.

For instance, the teachings herein may be used with fabrics that incorporate flame resistant fibres. In particular, flame resistant fibres could include polybenzimidazole (PBI) fibers, or flame resistant PBI fibers could be used in combination with aramid fibers, and in some cases with aramid cross-link fibers. In some other embodiments, glass may be another suitable yarn. In other embodiments, other suitable yarns may be used, such as aramids, chemically treated FR polyester, rayon, ceramic yarns, core spun glass fibers, carbon, preox, Nomex, and various blended spun yards.

While the above description provides examples of one or more fabrics, processes or apparatuses, it will be appreciated that other fabrics, processes or apparatuses may be within the scope of the present description as interpreted by one of skill in the art.

1. A method for treating a fabric, comprising:
a. contacting a water repellent compound to a raw fabric; and
b. curing the water repellent compound in an infrared module to form a treated fabric.

2.-11. (canceled)

12. The method of claim 1, wherein the compound is a fluoropolymer.

13.-14. (canceled)

15. The method of claim 1, wherein the infrared module is set to a temperature of less than 285 degrees Fahrenheit.

16. A method for treating a fabric, comprising:
contacting a water repellent compound to a raw fabric; and
removing excess water repellent compound before curing the water repellent compound using a vacuum module.

17. The method of claim 16, wherein the vacuum module includes one or more vacuum slots.

18. The method of claim 16, further comprising curing the water repellent compound in an infrared module to form a treated fabric.

19. The method of claim 18, wherein the curing step includes a first pass of the fabric though the infrared module and a second pass of the fabric through the infrared module.

20. The method of claims 18, wherein:
the curing step includes a first pass of the fabric though the infrared module and a second pass of the fabric through the infrared module; and
the removing excess water repellent compound step includes a first pass of the fabric though the vacuum module and a second pass of the fabric through the vacuum module.

21. The method of claim 16, wherein the water repellent compound is contacted to the raw fabric using a dip tank.

22. The method of claim 16, wherein the water repellent compound is contacted to the raw fabric using spray techniques.

23. The method of claim 16, wherein the water repellent compound is contacted to the raw fabric using a transfer roll.

24. The method of claim 16 a wherein the removing excess water repellent compound step includes a first pass of the fabric though the vacuum module and a second pass of the fabric through the vacuum module.

25.-28. (canceled)

29. A system for treating a fabric, comprising:
an apparatus for contacting a water repellent compound to a raw fabric; and
a vacuum module for removing excess water repellent compound before curing thereof.

30. The system of claim 29, further comprising an infrared module for curing the water repellent compound to form a treated fabric.

31. The system of claim 29, wherein the vacuum module includes one or more vacuum slots.

32. The system of claim 29, wherein the system further comprises a dip tank and the water repellent compound is contacted to the raw fabric in the dip tank.

33. The method of claim 16, wherein excess water repellent compound is removed using padders.

34. The method of claim 16, wherein the removing excess water repellent compound step includes a first pass of the fabric though the vacuum module and a second pass of the fabric through the vacuum module.

35. The method of claim 16, wherein the compound is a fluoropolymer.

36. The method of claim 18, wherein the infrared module is set to a temperature of less than 285 degrees Fahrenheit.
